(19) United States
(12) Patent Application Publication
(10) Pub. No.: US 2016/0356618 A1
(43) Pub. Date: Dec. 8, 2016

(54) METHOD AND APPARATUS FOR DISPLAY LOCATION INFORMATION

(71) Applicant: LEAUTO INTELLIGENT TECHNOLOGY (BEIJING) CO.LTD, Beijing (CN)

(72) Inventors: Haolong WANG, Beijing (CN); Guowei GAO, Beijing (CN); Tieying LI, Beijing (CN)

(21) Appl. No.: 14/971,933

(22) Filed: Dec. 16, 2015

(30) Foreign Application Priority Data
Jun. 3, 2015 (CN) 201510301071.X

(51) Int. Cl. G01C 21/36; G01S 19/13

(52) U.S. Cl. CPC G01C 21/367; G01C 21/3673; G01S 19/13

(57) ABSTRACT

The present disclosure provides a method and an apparatus for displaying location information. The method includes the following steps: obtaining an user position information and a target position information by a terminal; determining a position deviation message of the user position relative to a target position according to the user position information and the target position information; determining an user tracking region in a current interface according to the position deviation message; wherein, a relative direction of the target position and the user tracking region displayed in the current interface indicate a position deviation of the user position and the target position; and displaying an user position icon in the user tracking region. Therefore, the user may intuitively know the relative direction between the place of the user and the target position, thereby increasing the obtaining efficiency of the location information for the user effectively.

### CROSS REFERENCE TO RELATED APPLICATION

This application claims priority under 35 U.S.C. §119(a) to Patent Application No(s). 201510301071X, filed in China on Jun. 3, 2015, the entire contents of which are hereby incorporated by reference.

### FIELD OF TECHNOLOGY

The present disclosure is related to computer technology field, and more particular to a method and an apparatus for display location information.

### BACKGROUND

With the development of information technology, the network service providers can provide various types of network services such as location based services (LBS) for users to accessing Internet.

The location based service obtains the location information (such as the latitude and longitude coordinate data) of the terminal used by the user through the corresponding location technology, and the obtained location information is provided to the user (also other users), the network service providers, so as to achieve a variety of services related to the positions.

In the prior art, the user may use the terminal to acquire the corresponding location based service, so as to query the current position of the user and the target position. For example, the user may use the map in the terminal to query the corresponding target position.

However, the manner for location of the prior art only displays the located position, and the relationship with the user's current location is low, resulting in the lower efficiency for obtaining the position information for the user.

### SUMMARY

An embodiment of the present disclosure provides a method and an apparatus for display location information, thereby solving the problem of the lower efficiency for obtaining the position information for the user.

An embodiment of the present disclosure provides a method for displaying location information, which includes:

obtaining user position information and a target position information by a terminal;

determining position deviation information of the user position relative to a target position according to the user position information and the target position information;

determining a user tracking region in a current interface according to the position deviation information; wherein, a relative direction of the target position and the user tracking region displayed in the current interface indicates a position deviation of the user position and the target position; and

displaying a user position icon in the user tracking region.

An embodiment of the present disclosure further provides apparatus used for displaying a location information, which includes:

a processor; and

a memory containing a program, when executed by the processor, the processor executes the following steps:

obtaining user position information and a target position information by a terminal;

determining a position deviation message of the user position relative to a target position according to the user position information and the target position information;

determining an user tracking region in a current interface according to the position deviation message; wherein, a relative direction of the target position and the user tracking region displayed in the current interface indicate a position deviation of the user position and the target position; and

displaying a user position icon in the user tracking region.

The embodiment of the present disclosure provides a method and an apparatus for displaying location information. When the user uses the position service of the terminal to query the target position, the terminal may obtain the target position information and the user position information of the user at the same time, calculate the deviation information between the current position of the user and the target position and then adjust the displayed position of the user position icon in the location interface according to the deviation information. Therefore, the user may intuitively know the relative direction between the location of the user and the target position, thereby increasing efficiency of obtaining the location information for the user effectively.

### BRIEF DESCRIPTION OF THE DRAWING(S)

In order to more clearly illustrate the technical schemes of the prior art or the embodiments of the present disclosure, the accompanying drawings for illustrating the prior art or the embodiments of the present disclosure are briefly described as below. It is apparently that the drawings described below are merely some embodiments of the present disclosure, and those skilled in the art may derive other drawings according the drawings described below without creative endeavor. In the drawings:

FIG. 1 is a schematic view of a process for displaying location information according to the embodiment of the present disclosure;

FIG. 2A is a schematic view of a target position and a current position of the user according to the embodiment of the present disclosure;

FIG. 2B is a schematic view of a target position and a user position icon displayed in the location interface at the same time according to the embodiment of the present disclosure;

FIG. 2c is a schematic view of a target position and a current position of the user displayed in the location interface at the same time according to the embodiment of the present disclosure;

FIG. 3 is a schematic view of after dragging the location interface by the user according to the embodiment of the present disclosure;

FIG. 4 is a structure schematic view of an apparatus for display location information according to the embodiment of the present disclosure; and

FIG. 5 is a schematic view of an apparatus used for displaying a location information according to one embodiment of the present disclosure.

### DESCRIPTION OF THE EMBODIMENTS

For the purpose, technical solution, and advantage of the present disclosure becoming clearer, the specific embodiments of the present disclosure combined with the accompanying drawings to clearly and completely are described as follows. Obviously, the described embodiments are only part of the embodiments of the present disclosure rather than all embodiments. Based on the embodiments of the present disclosure all other embodiments obtained by those having ordinary skills in this field without creative work are within the scope of protection of the present disclosure.

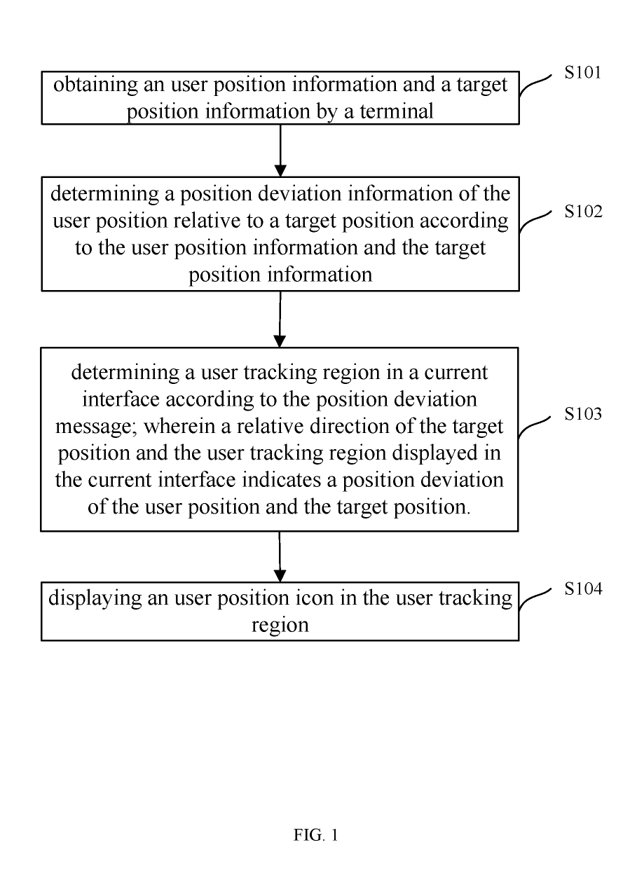

FIG. 1 is a schematic view of a process for display location information according to the embodiment of the present disclosure. The process includes the following steps:

Step S101: obtaining user position information and a target position information by a terminal.

The terminal may be, but not limited to, an intelligent mobile terminal such as a smart phone, a tablet computer, a notebook computer or a computer terminal.

When the user needs to query a target location, the user may usually use a position based services (such as map application) to query the target location. In this case, the terminal intuitively displays the target position which the user intends to query to the user. Thus the terminal needs to obtain target position information. In order to facilitate the user to know his/her position in a current time, the terminal further obtains position information of the current place which the user is located at, i.e. user position information.

In the present disclosure, if the terminal is a mobile terminal, and the terminal may obtain the user position information of the user and the target position information through the built-in global positioning system (GPS) chip, or sending a position request to a mobile service operator. If the terminal is a computer terminal, and then the terminal may obtain the user position information of the user through querying a distribution of IP address from the internet server and query the target position information through the position server. Of course, the above manner for obtaining the position information is not intended to limit the present disclosure.

In the embodiment of the present disclosure, the user position information and the target position information include, but are not limited to, latitude and longitude information, geographic coordinate information, altitude information included in a information in response to the geographic position.

Step S102, determining position deviation information of the user position relative to a target position according to the user position information and the target position information.

After the terminal obtains the user position information of the user and the target position information, the terminal may calculate and obtain a deviation of the latitude and longitude (or geographic coordinate) between the two positions according to the latitude and longitude information included in the two position information (or the geographical coordinate information), thereby determining the position deviation information of the two positions.

Further, in the embodiment of the present disclosure, a deviation distance and a deviation direction between the two positions may be determined by the position deviation information. After the terminal obtains the position deviation information, the terminal dynamically displays a user tracking region according the target message which the user intends to query, i.e. the following Step S103.

Step S103: determining a user tracking region in a current interface according to the position deviation message.

a relative direction of the target position and the user tracking region displayed in the current interface indicates a position deviation of the user position and the target position.

In the embodiment of the present disclosure, the current interface is a location interface displayed by the terminal, and the location interface herein includes, but is not limited to, an application interface or a web page such as the electronic map with a function for displaying location information.

In the prior art, the location interface often displays the user position icon in the user tracking region, and the user position icon may be used for operation, i.e. if the user clicks the user position icon, and then the location interface tracks a current position of the user and the current position is displayed in the location interface. However, in the prior art, the displayed position of the user tracking region located on the location interface is fixed, and it does not reflect the target position which the user wants to query and the direction of the current position of the user.

In the embodiment of the present disclosure, different from the prior art, the position deviation message determined by the terminal through the above steps reflect the deviation of the actual latitude and longitude (or geographic coordinate) between the current position and the target position. In the location interface, the terminal may calculate a relative position of the user tracking region relative to the target position according to the deviation of the actual latitude and longitude (or geographic coordinate) between the current position and the target position. Therefore, the relative position of the target position and the user tracking region also indicate the deviation of the actual position between the user position and the target position.

Step S104: displaying a user position icon in the user tracking region.

After the terminal determines the user tracking region in the current interface, the terminal displays the user position icon in the user tracking region.

Of course, in the embodiment of the present disclosure, in addition to displaying the user position icon, the user tracking region also may display a thumbnail image, a real photo, etc. of the position of the user. The content displayed in the user tracking region can be changed according to the need of the practical application. Herein it is not intended to limit the present disclosure.

Combined with the methods of the above steps, an example will be provided for description.

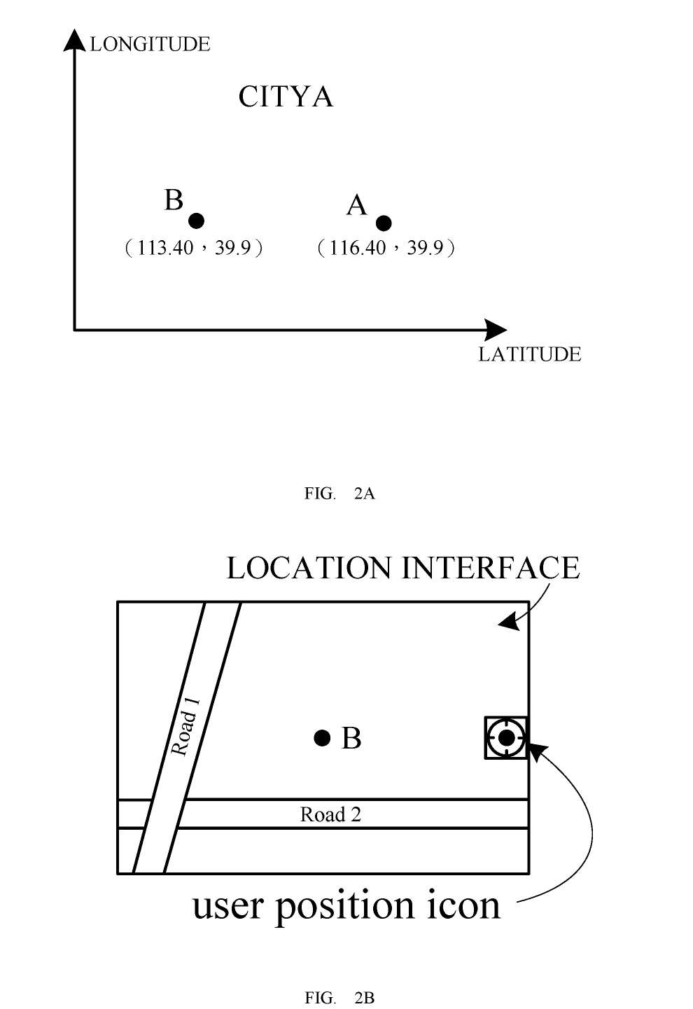

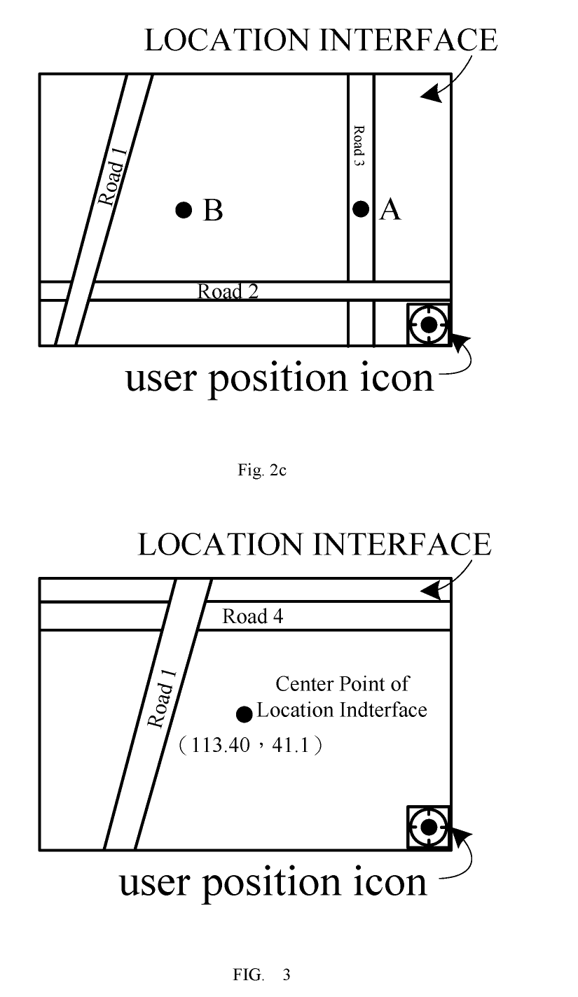

For example, as shown in FIG. 2A, in FIG. 2A, a geographic coordinate system is used to represent a position of each point, wherein, the abscissa indicates the latitude, the ordinate indicates the longitude. Assuming the position of the user is at a point A of the city A, the geographical coordinate position of the point A is (116.40,39.9), the target position which the user wants to query is a point B of the city A, and the geographical coordinate position of the point B is (113.40,39.9). In FIG. 2, it can be seen that the actual position of point A is located in the east of point B (the deviation of the latitude and longitude 3).

Therefore, when the user uses the position service of the terminal to query the position of the point B, in the location interface displayed by the terminal, the terminal may display the displayed position of the user tracking region according to the deviation of the latitude between the point A and the point B, as shown in FIG. 2. In FIG. 2, the user position icon is displayed in the user tracking region, and the user tracking region is located in the right side of the location interface to indicate the current position of the user (the point A) is located in the east of point B

As shown in the above example, the user position icon displayed by the location interface indicates a direction of the current position of the user (the point A) relative to the target position (the point B). In the practical application, when the target position in the location interface changes, then the displayed position of the user position icon also changes accordingly. Similarly, if the current position of the user changes, then the displayed position of the user position icon also changes accordingly.

In the actual application, the user may query the target position in the location interface of the terminal. The user wants to know the relative direction between his position and the target position. However, in the prior art, the displayed position of the user tracking region is fixed, it does not reflect the relative direction between the user position and the target position, and then the user only separately query the target position and the user position. If the target position is far apart from the user position, the user also needs to respectively query the target position and the user position for many times, and record by himself This shows that the convenience of such location manner is very low, resulting in a lower efficiency of obtaining the location information for the user.

Thus, by using the above steps and the above examples, it is understood that when the user uses the position service of the terminal to query the position, the terminal obtains the target position information and the user position information of the user at the same, calculates the deviation between the current position of the user and the target position, and then adjusts the displayed position of the user position icon in the location interface according the calculated deviation. Therefore, the user may intuitively know the relative direction between the place of the user and the target position in the location interface in real time, thereby increasing an obtaining efficiency of the location information for the user.

It should be noted that, if the location interface may display the target position and the user position, then the user may intuitively know his direction in the location interface and the relative position between the direction and the target position. When the current position of the user is not displayed in the location interface, it only needs to display the relative direction between the current position of the user and the target position by using the manner of the user tracking region.

Therefore, in the embodiment, the user tracking region is determined in the current interface according to the position deviation information. The specific details are as follows. The terminal monitors the current interface, and when the terminal monitors the user position not displayed in the current interface, the terminal determines the user tracking region in the current interface according to the position deviation information; when the terminal monitors the current position of the user displayed in the current interface, the terminal displays the user tracking region in the predetermined displayed position of the current interface.

For example, following the above example, in FIG. 2B, the current location interface only displays the target position (the point B) and does not display the point A of the user. Therefore, in the location interface as shown in FIG. 2, the terminal displays the direction of the point A relative to the point B by using the manner of the user position icon (i.e. the user tracking region) according the position deviation information between both places A and B.

At this time, if the user zooms out the display scale of the location interface, such that the location interface may display both places A and B at the same time, then in the current location interface, the terminal may display the user position icon on the default displayed position, as shown in FIG. 2C. In FIG. 2C, the user may directly views the specific location of both places A and B in the location interface without using the manner of the user position icon to indicate the relative direction, and thus the user position icon of the location interface is displayed at bottom right corner (i.e. the default display position).

Of course, the display manner of the above example merely is one example of the embodiment of the present disclosure, and it is not intended to limit the present disclosure.

It is seen from the above description, in the embodiment of the present disclosure, that the display manner for the user position icon is related to the target position. Herein, it needs to be noted that, in one case of the actual application, the user may directly click some position in the location interface, so that the terminal may make the position clicked by the user serve as the target position queried by the user. Or, the user searches and queries for some places (e.g., entering the name of the target location), and then the location interface may also make the queried position according to the search term of the user serve as the target position.

That is, in the above case, the target position includes a target position generated by using the location operation of the user. The location operation includes, but is not limited to, a search operation and/or a click operation.

In the practical application, in addition to the above case, the user does not perform the location operation of clicking or searching in the location interface, and then in this case, the terminal makes the position indicated by the center point of the location interface serve as the target position.

That is, in the above case, the target position includes a target position indicated by the center of the location interface.

Additionally, considering the practical application, the user usually performs the corresponding operation in the location interface, such as the user may drag the current location interface to query information of other target positions. Since the user performs the operation in the location interface, it is capable of affecting the displayed position of the user position icon. Therefore, in the embodiment of the present disclosure, when the target position indicated by the center point of the current interface, the method further includes the terminal receives the specific operation of the user in the current interface, and adjusts the displayed position of the user tracking region according to the specific operation.

The specific operation includes, but is not limited to, a drag operation for the location operation.

For the above specific operation, the different operations may allow the displayed positions on the location interface of the user position icons to have the different changes, and then the terminal may use the different manners to adjust the displayed positions of the user tracking regions. A drag operation for the location interface included in the specific operation and the scene of the target position indicated by the center point of the location included in the target position will be described in details as follows.

In the scene, adjusting the displayed position of the user tracking region is specified as: the terminal obtains the position corresponding to the center point of the current interface after dragging, determines the position deviation message between the current position of the user and the position indicated by the center point according to the position information of the obtained center point and the obtained user position information, and then adjusts the displayed position of the user tracking region according to the position deviation message.

In the practical application, the user may query some target position, and then the user may drag the location interface to obtain a target position required by the user. In the process of dragging the location interface by the user, the user tracking region in the location interface may continue to change; this is because the user drags the target position indicated by the center point to change continuously. That is, the target position indicated by the center point continues to change, and then the relative position between the current position of the user and the target position also continue to change. Therefore, in the embodiment of the present disclosure, once the terminal monitors the drag operation for the location interface, and then the terminal obtains the position information corresponding to the center point in the location interface in real time to serve as the target position information.

For example, assuming the basis of the location interface as shown in FIG. 2B, the user performs the drag operation downward (i.e. the content displayed by the location interface integrally moves downward) for the location interface as shown in FIG. 2B, and after dragging, the location interface is shown in FIG. 3. In FIG. 3, the geographical coordinate of the place corresponding to center point of the location interface is (113.40,41.1). Then, the terminal may obtain the position information corresponding to the center point and the position deviation information between both places is determined by the user position information of the known user position (the point A). Obviously, the place corresponding to the center point of the location interface as shown in FIG. 3 is located in the north side of B as shown in FIG. 2, which indicates that point A is located in a southeast side of the center point. Thus, the terminal may adjust the user tracking region in the location interface (i.e. the user position icon is displayed in the user tracking region), i.e. the user position icon moves from the displayed position as shown in FIG. 2 to the displayed position as shown in FIG. 3.

It is seen from the above example that the terminal dynamically adjusts the displayed position of the user tracking region in the location interface according to the drag operation for the location operation, such that in the process of querying the target position, the user knows the relative direction between his position and the target position in real time.

Of course, in the embodiment of the present disclosure, the user may perform a rotating operation for the location interface, and then the terminal may also obtain a rotating angle of the location interface, so as to adjust the displayed position of the user tracking region according to the rotating angle. Herein, it is not intended to limit to the present disclosure.

Furthermore, in the embodiment of the present disclosure, since the position deviation information also includes the deviation distance between both places, serving as a display manner of the embodiment of the present disclosure, the location interface further displays a straight line distance of the location point of the current position distance of the user, and the straight line distance between both places changes in real time following the change of the current position of the user of the change of the location point.

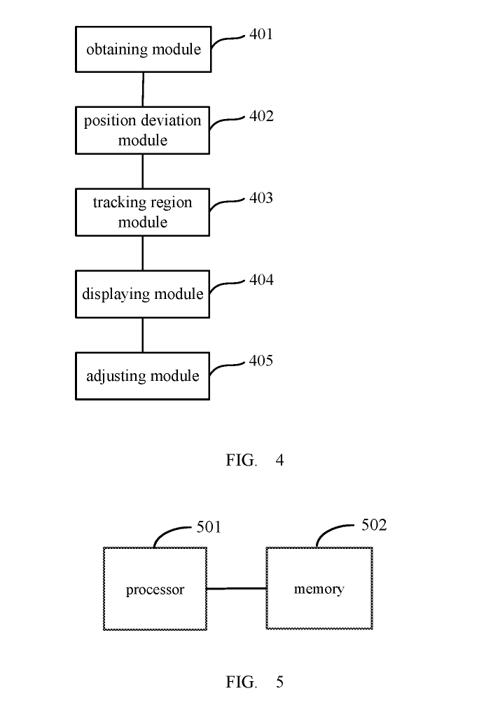

The above embodiment is the method for displaying the location information provided by the embodiment of the present disclosure, and based on the same concept, the embodiment of the present disclosure also provides an apparatus for displaying location information, as shown in FIG. 4.

In FIG. 4, the apparatus for displaying the position information is configured in the terminal. The apparatus includes an obtaining module 401, a position deviation module 402, a tracking region module 403 and a displaying module 404.

The obtaining module 401 is used for obtaining user position information and a target position information.

The position deviation module 402 is used for determining a position deviation message of the user position relative to a target position according to the user position information and the target position information.

The tracking region module 403 is used for determining a user tracking region in a current interface. A relative direction of the target position and the user tracking region displayed in the current interface indicates a position deviation of the user position and the target position.

The displaying module 404 is used for displaying a user position icon in the user tracking region.

In the embodiment of the present disclosure, the tracking region module 403 monitors the current interface by the terminal, and when the terminal monitors the user position not displayed in the current interface, a terminal determines the user tracking region in the current interface according to the position deviation message.

In the embodiment of the present disclosure, the target position includes a target position generated by a location operation of the user and/or a target position indicated by a center point of the current interface. The location operation includes at least one of a search operation and a click operation.

The apparatus further includes an adjusting module 405, wherein when the target position includes the target position indicated by the center point of the current interface, the adjusting module 405 receives an assigned operation of the user in the current interface, and adjusts a display position of the user tracking region according to the assigned operation.

The assigned operation includes a drag operation for the location interface.

When the assigned operation includes the drag operation for the location interface, the adjusting module 405 obtains a position information relative to the center point in the current interface after dragging by the terminal, determines the position deviation message of the user position and the position indicated by the center point according to the obtained position information of the center point and the obtained user position information, and adjusts the display position of the user tracking region according to the position deviation message.

FIG. 5 is a schematic view of an apparatus used for displaying a location information according to one embodiment of the present disclosure. The apparatus used for displaying the location information includes:

a processor 501; and

a memory 502 containing a program, when executed by the processor, the processor executes the following steps:

obtaining user position information and a target position information by a terminal;

determining a position deviation message of the user position relative to a target position according to the user position information and the target position information;

determining an user tracking region in a current interface according to the position deviation message; wherein, a relative direction of the target position and the user tracking region displayed in the current interface indicate a position deviation of the user position and the target position; and

displaying a user position icon in the user tracking region.

In the embodiment of the present disclosure, the relevant functional modules may be implemented by using the hardware processor.

The apparatus embodiments described above are merely illustrative, wherein the unit described as a separate member may or may not be physically separate, and as part of the display unit may or may not be physical units, i.e., it may be located in one place, or may be distributed to various network elements. Some or all of the modules may be selected to achieve the purpose of the present examples of the embodiments according to the actual need. Those of ordinary skill in the case may understand and implement the present disclosure without paying any creative work.

The above description of embodiments, those skilled in the art can clearly understand the various embodiments may be implemented by software plus a necessary universal hardware platform for implementation, and of course, also be implemented by hardware. Based on this understanding, the nature of the technical proposal or the part contributing to the prior art may be embodied in the form of a software product. The computer software product may be stored in a computer readable storage medium, such as ROM/RAM, magnetic disc, CD-ROM, including several instructions to instruct a computer device (a personal computer, a server, or a network equipment) to perform the method described in some parts of the various embodiments or examples.

Finally, it should be noted that the above embodiments are merely provided for describing the technical solutions of the present disclosure, but not intended to limit the present disclosure. Although reference to the embodiments of the present disclosure has been described in details, those skilled in the art will appreciate that the technical solutions described in the foregoing embodiments can be modified, or equivalently replaced for some technical features; and such modifications or replacements do not make the essence of the corresponding technical solutions depart from the spirit and scope of the technical implementation of the present disclosure.

What is claimed is:

1. A method for display a location information, comprising:
obtaining user position information and a target position information by a terminal;
determining a position deviation message of the user position relative to a target position according to the user position information and the target position information;
determining an user tracking region in a current interface according to the position deviation message; wherein, a relative direction of the target position and the user tracking region displayed in the current interface indicate a position deviation of the user position and the target position; and
displaying a user position icon in the user tracking region.

2. The method according to claim 1, wherein the step of determining a position deviation message relative to a target position according to the user position information and the target position information comprises:
monitoring the current interface by the terminal; and
determining the user tracking region in the current interface by the terminal according to the position deviation message when the terminal monitors the user position not displayed in the current interface.

3. The method according to claim 2, wherein the target position comprises a target position generated by a location operation of the user and/or a target position indicated by a center point of the current interface;
wherein, the location operation comprises at least one of a search operation and a click operation.

4. The method according to claim 3, wherein when the target position comprises the target position indicated by the center point of the current interface, the method further comprises:
receiving an assigned operation of the user in the current interface by the terminal; and
adjusting a display position of the user tracking region according to the assigned operation;
wherein, the assigned operation comprises a drag operation for a location interface.

5. The method according to claim 4, wherein when the assigned operation comprises the drag operation for the current interface, the step of adjusting the display position of the user tracking region comprises:
obtaining a position information relative to the center point in the current interface after dragging by the terminal;
determining the position deviation information of the user position and the position indicated by the center point according to the obtained position information of the center point and the user position information has been obtained; and
adjusting the display position of the user tracking region according to the position deviation information.

6. The method according to claim 1, wherein the target position comprises a target position generated by a location operation of the user and/or a target position indicated by a center point of the current interface;
wherein, the location operation comprises at least one of a search operation and a click operation.

7. An apparatus, used for displaying a location information, the apparatus comprising:
a processor; and
a memory containing a program, when executed by the processor, the processor executes the following steps:
obtaining user position information and a target position information by a terminal;
determining a position deviation message of the user position relative to a target position according to the user position information and the target position information;
determining an user tracking region in a current interface according to the position deviation message; wherein, a relative direction of the target position and the user tracking region displayed in the current interface indicate a position deviation of the user position and the target position; and
displaying a user position icon in the user tracking region.

8. The apparatus according to claim 7, wherein the step of determining a position deviation message relative to a target position according to the user position information and the target position information comprises: monitoring the current interface by the terminal; and determining the user tracking region in the current interface by the terminal according to the position deviation message when the terminal monitors the user position not displayed in the current interface.

9. The apparatus according to claim 8, wherein the target position comprises: a target position generated by a location operation of the user and/or a target position indicated by a center point of the current interface;
wherein, the location operation comprises at least one of a search operation and a click operation.

10. The apparatus according to claim 9, wherein when the target position comprises the target position indicated by the center point of the current interface, the processor further executes the following steps: receiving an assigned operation of the user in the current interface, and adjusting a display position of the user tracking region according to the assigned operation;
wherein, the assigned operation comprises: a drag operation for a location interface.

11. The apparatus according to claim 10, wherein when the assigned operation comprises the drag operation for the current interface, the step of adjusting the display position of the user tracking region comprises:
obtaining a position information relative to the center point in the current interface after dragging by the terminal; determining the position deviation message of the user position and the position indicated by the center point according to the obtained position information of the center point and the user position information has been obtained, and adjusting the display position of the user tracking region according to the position deviation information.

12. The apparatus according to claim 7, wherein the target position comprises: a target position generated by a location operation of the user and/or a target position indicated by a center point of the current interface;
wherein, the location operation comprises at least one of a search operation and a click operation.
